(19) United States
(12) Patent Application Publication
(10) Pub. No.: US 2009/0033733 A1
(43) Pub. Date: Feb. 5, 2009

(54) INKJET PRINTER

(75) Inventors: Yoshihisa HIGASHIMOTO, Wakayama (JP); Nobuaki NAKAOKA, Wakayama (JP)

Correspondence Address: Studebaker & Brackett PC, 1890 Preston White Drive, Suite 105, Reston, VA, 20191, US

(73) Assignee: NORITSU KOKI CO., LTD., Wakayama (JP)

(21) Appl. No.: 12/182,382

(22) Filed: Jul. 30, 2008

(30) Foreign Application Priority Data
Aug. 2, 2007 (JP) 2007-202176

(51) Int. Cl. B41J 2/01

(52) U.S. Cl. 347/104

(57) ABSTRACT

A paper web not in use for printing is put on standby at a standby position in which the leading edge of the paper web is located upstream of a meeting point of paper conveyance paths and a closing roller bears against a margin of the paper web.

### CROSS-REFERENCES TO RELATED APPLICATIONS

This application claims priority under 35 USC 119 to Japanese Patent Application No. 2007-202176 filed on Aug. 2, 2007, the entire contents of which are incorporated herein by reference.

### BACKGROUND OF THE INVENTION

(a) Field of the Invention

This invention relates to inkjet printers.

(b) Description of the Related Art

Inkjet printers are conventionally known as devices for printing characters and images (hereinafter, characters and images are generically called “images”). The inkjet printers print images on paper by reciprocal movement in the paper width direction of their print heads ejecting ink.

Published Japanese Patent Application No. 2006-181982 discloses a technique of selectively conveying a plurality types of paper contained in different containers, such as a magazine container and a cassette container, to fill orders for various print sizes. Out of the plurality of types of paper, a long web of rolled paper (a long rolled paper web) is printed with a plurality of images at longitudinally spaced intervals and then cut in units of images by a cutter. To-be-printed regions of the rolled paper web on which images are to be printed are previously determined based on print size or other order information.

Published Japanese Patent Application No. 2005-271433 discloses a technique in which a rid is provided over a paper output slit in a paper magazine capable of containing a long paper web for inkjet printers and having an airtight structure and, when the paper web is not in use, the paper output slit is closed by the rid to prevent that the paper web absorbs moisture and thereby causes color shading due to uneven ink absorptivity or paper undulation when printed afterwards.

In the above techniques, in selectively conveying a plurality of types of paper according to the ordered print size, a paper web having been conveyed and residing on the conveyance path before the selection of paper type is first rewound to a predetermined standby position and put on standby and a type of paper to be printed is then fed onto the conveyance path. In this standby position, the entire paper web is not contained in the paper magazine but part thereof is left outside the paper magazine.

### SUMMARY OF THE INVENTION

In the known inkjet printers as described above, the printing quality of the paper web may be affected depending upon the standby position of the paper web. Specifically, if a paper web is on standby in a state that a part of a single to-be-printed region to be printed with a single image is left outside the paper magazine and the remaining part of the paper web is inside the paper magazine, the single to-be-printed region has different moisture retention conditions therewithin because of a difference in the range of humidities between inside and outside the paper magazine. Therefore, the same to-be-printed region of the paper web has a variation in ink absorptivity, which may result in color shading of a print obtained by printing of the paper web.

The present invention has been made in view of the foregoing points and, therefore, an object thereof is to provide an inkjet printer that prevents a single print from having color shading therewithin and thereby achieves high-quality printing.

To attain the above object, in the present invention, a paper web not in use for printing is put on standby at a standby position in which a closing member disposed in the vicinity of an opening of a containing room for the rolled paper web bears against a margin of the paper web.

More specifically, the present invention is directed to an inkjet printer including: a plurality of containing parts for containing a plurality of types of paper, one containing part for each type of paper; and a plurality of conveyance paths provided one for each of the plurality of containing parts, and being configured to select one of the plurality of conveyance paths for each type of paper, convey the paper to a print head along the selected conveyance path and print an image on the paper, and takes the following solutions.

Furthermore, in a first aspect of the invention, the inkjet printer further includes a conveyance roller, disposed downstream of a meeting point of the downstream ends of the plurality of conveyance paths in a direction of paper conveyance, for conveying the paper to the print head, the plurality of types of paper include at least one type of long rolled paper web having: a plurality of to-be-printed regions on each of which an image is to be printed; and margins provided at the leading edge of the paper web and between each two of the plurality of to-be-printed regions adjacent in a longitudinal direction of the paper web, the containing part for containing the paper web comprises a containing room including an airtight space, the inkjet printer further includes a closing member, disposed in the vicinity of an opening for paper conveyance opening into the containing room, for closing the opening, and the inkjet printer is configured so that, out of the plurality of types of paper, the paper web not in use for printing is put on standby at a standby position in which the leading edge of the paper web is located upstream of the meeting point in the direction of paper conveyance and the closing member bears against one of the margins of the paper web.

Since in the above manner the paper web not in use for printing is put on standby at a standby position in which the leading edge of the paper web is located upstream of the meeting point of the downstream ends of the conveyance paths to avoid the interference of the leading edge of the paper web with the conveyance of the other types of paper and the closing member bears against one of the margins of the paper web, each single to-be-printed region of the surface of the paper web can be kept in a uniform moisture retention condition. In other words, at the standby position of the paper web, the whole area of each single to-be-printed region of the paper web is inside or outside the containing part. Therefore, even if the humidity condition differs between inside and outside the containing part, each single to-be-printed region is prevented from having different ink absorptivities within it. This prevents a print obtained by printing on the paper web from causing color shading, resulting in providing a high-quality print.

A second aspect of the invention is the inkjet printer according to the first aspect of the invention, wherein the containing room is kept within a predetermined range of humidities, and the inkjet printer is configured so that, out of the plurality of types of paper, the paper web not in use for printing is put on standby at a standby position in which the closing member bears against the margin at the leading edge of the paper web.

Since in the above manner the paper web not in use for printing is put on standby, in the containing part kept within the predetermined range of humidities, at a standby position in which the closing member bears against the margin at the leading edge of the paper web, all of the to-be-printed regions of the paper web can be contained in the containing part having a good moisture retention condition. Thus, every single to-be-printed region is prevented from having different ink absorptivities within it. This prevents a print obtained by printing on the paper web from causing color shading, resulting in providing a high-quality print.

A third aspect of the invention is the inkjet printer according to the first aspect of the invention, wherein a drive roller for feeding forward the paper web in the direction of paper conveyance and rewinding the paper web is disposed between the conveyance roller and the containing room.

Thus, the forward feeding and rewinding of the paper web involved in the switching among the paper conveyance paths can be carried out by the drive roller, whereby the paper web not in use for printing can be automatically put on standby at a standby position. This enhances workability.

A fourth aspect of the invention is the inkjet printer according to the third aspect of the invention, wherein the drive roller is composed of the closing member formed into a roller.

Thus, the forward feeding and rewinding of the paper web involved in the switching among the paper conveyance paths can be carried out by the closing member. This eliminates the need to additionally provide a drive roller exclusive for the feeding and rewinding of the paper web. This is advantageous in providing space saving and cost reduction of the inkjet printer.

A fifth aspect of the invention is the inkjet printer according to the fourth aspect of the invention and further including a driving force transmission device configured to be switchable between a transmission state in which the rotational driving force of the conveyance roller is transmitted to the drive roller to drive the drive roller into rotation in synchronism with the conveyance roller and a non-transmission state in which the rotational driving force of the conveyance roller is not transmitted to the drive roller to stop the drive roller.

Thus, the drive roller can be driven into rotation by the driving force transmission device using the driving force of a drive motor for driving the conveyance roller into rotation. Therefore, there is no need to additionally provide a motor or the like exclusive for the drive roller, which is advantageous in space saving and cost reduction of the inkjet printer. For example, a solenoid clutch attached to the roller shaft of the conveyance roller to be capable of engagement with and disengagement from the drive roller may be used as the driving force transmission device. Thus, whether or not to rotate the drive roller can be selected simply by switching the solenoid clutch between ON and OFF.

As described above, according to the inkjet printer of the present invention, the paper web not in use for printing is put on standby at a standby position in which the leading edge of the paper web is located upstream of the meeting point of the downstream ends of the conveyance paths to avoid the interference of the leading edge of the paper web with the conveyance of the other types of paper and the closing member bears against one of the margins of the paper web. Therefore, each single to-be-printed region of the surface of the paper web can be kept in a uniform moisture retention condition. The paper web surface has difference moisture retention conditions between a region against which the closing member bears and a region against which the closing member does not bear. However, since in the present invention the closing member does not bear against the to-be-printed regions, each single to-be-printed region of the paper web surface can be kept in a uniform moisture retention condition.

In other words, at the standby position of the paper web, the whole area of each single to-be-printed region of the paper web is inside or outside the containing part. Therefore, even if the humidity condition differs between inside and outside the containing part, each single to-be-printed region is prevented from having different ink absorptivities within it. This prevents a print obtained by printing on the paper web from causing color shading, resulting in providing a high-quality print.

### BRIEF DESCRIPTION OF THE DRAWINGS

FIG. 1 is a perspective view showing the appearance of an inkjet printer according to an embodiment of the present invention and serving as an image forming apparatus.

FIG. 2 is a perspective view showing the structure of the inkjet printer inside a housing.

FIG. 3 is a plan view showing the structure of the inkjet printer inside the housing.

FIG. 4 is a front view showing the structure of the inkjet printer inside the housing.

FIG. 5 is a left side view showing the structure of the inkjet printer inside the housing.

FIG. 6 is a rear view showing the structure of the inkjet printer inside the housing.

FIG. 7 is a schematic diagram of the inkjet printer when viewed from the left of the housing, showing a conveyance path of printing paper.

FIG. 8 is a perspective view showing the structure of a solenoid clutch.

FIG. 9 is a view showing a standby position of a paper web not in use for image printing.

FIG. 10 is a view showing another standby position of the paper web not in use for image printing.

FIG. 11 is a cross-sectional view showing the structure of a drying unit when viewed from the left of the housing.

### DETAILED DESCRIPTION OF THE INVENTION

A description is given below of an embodiment of the present invention with reference to the drawings. The following preferred embodiment is merely illustrative in nature and is not intended to limit the scope, applications and use of the invention.

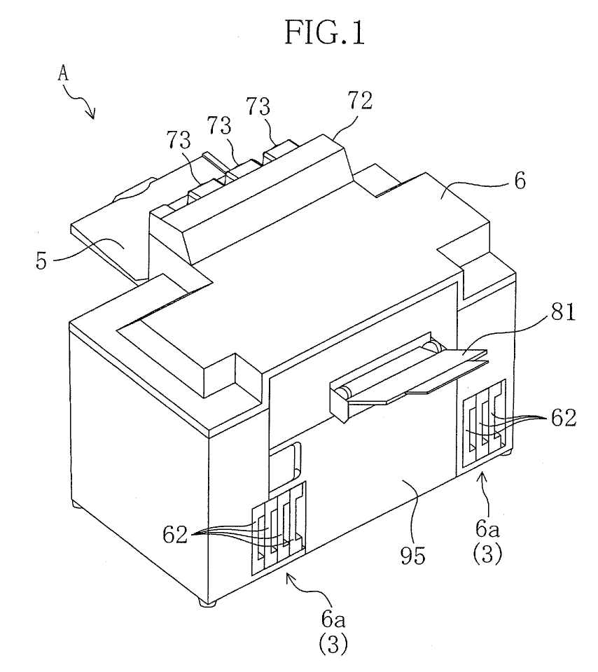

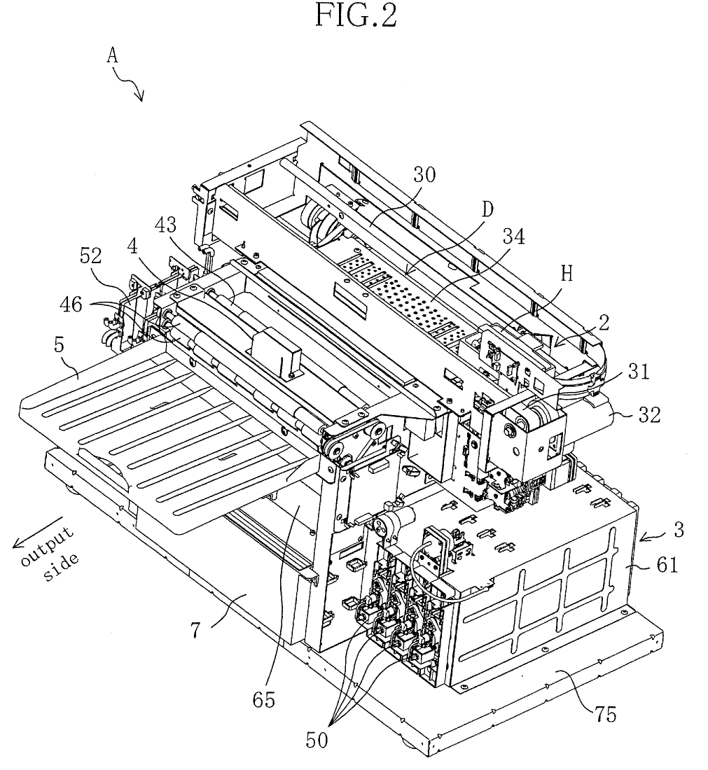

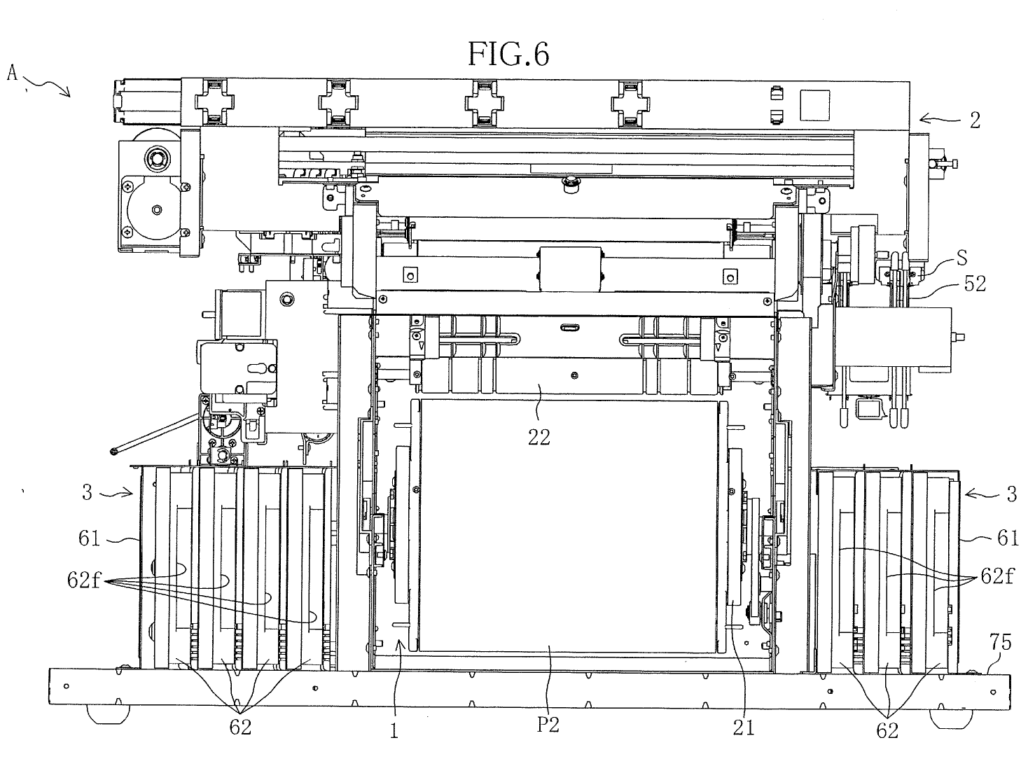

FIG. 1 shows the appearance of an inkjet printer A according to an embodiment of the present invention and FIGS. 2 to 7 show the internal structure of the inkjet printer A. The inkjet printer A is used for a photographic printing system and, for example, used for printing photographic images on printing paper P1 or P2 based on image data transmitted via a communication cable from a reception block for obtaining the image data and correcting it as necessary. More specifically, the inkjet printer A is configured to be capable of performing an automatic printing for pulling out one end of a long roll of printing paper P2 and printing an image on the printing surface of the roll of printing paper P2 (hereinafter, referred to as a paper web P2) and a manual-feed printing for printing an image on the printing surface of a sheet of printing paper P1 (hereinafter, referred to as a paper sheet P1) previously cut in a given size.

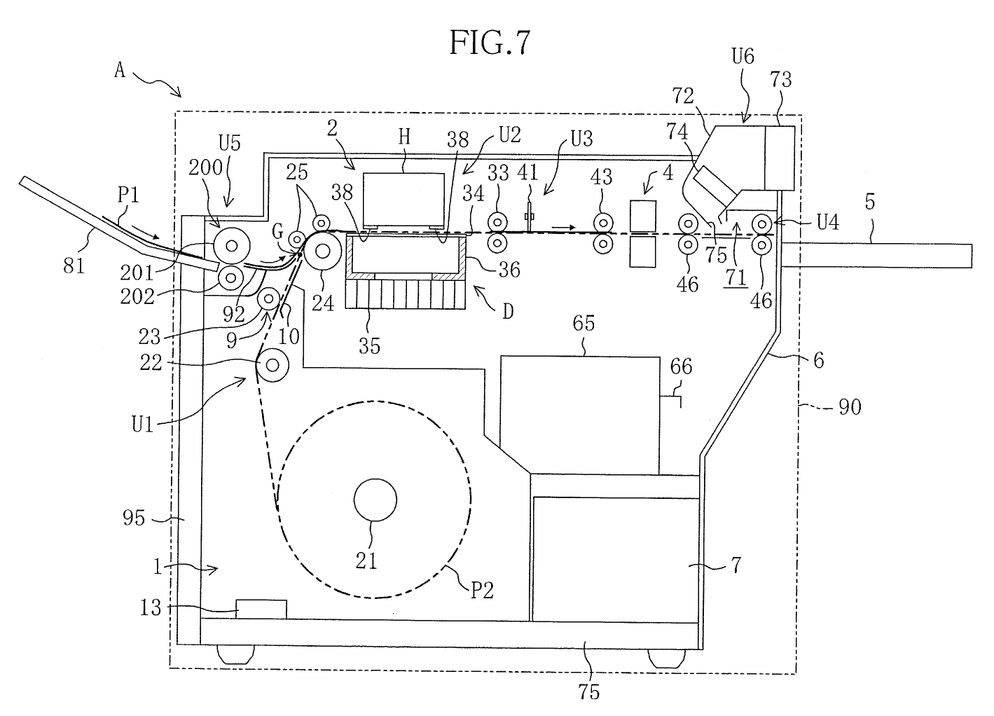

Note that when in the following description the paper web P2 and the paper sheet P1 need not be particularly distinguished, they are referred to as printing paper P1 or P2. Furthermore, the printing surface means the surface on which an image is to be printed. The printing surface of each paper sheet P1 is determined when the paper sheet P1 is set on a manual-feed tray 81 (see FIG. 7). Specifically, the printing surface is the side of the paper sheet P1 facing upward when the paper sheet P1 is set on the manual-feed tray 81. On the other hand, the printing surface of the paper web P2 is the side thereof facing radially outward when the paper web P2 is rolled.

### —General Structure—

As shown in FIG. 7, the inkjet printer A includes a printer body 90 and a manual-feed tray 81 for manually setting a paper sheet P1 thereon and feeding it therefrom into the printer body 90. The printer body 90 includes: a housing 6; a paper roll containing part 1 (containing room) disposed in a lower part of the interior of the housing 6 and containing a paper web P2 rolled with its printing surface outside; a printing part 2 (see FIGS. 2 and 7), disposed in an upper part of the interior of the housing 6 (above the paper roll containing part 1), for printing based on image data an image on the printing surface of the paper sheet P1 fed from the manual-feed tray 81 or the printing surface of the paper web P2 pulled out of the paper roll containing part 1; ink storages 3, located in the lower part of the interior of the housing 6 on both sides of the paper roll containing part 1, for storing ink to be supplied to the printing part 2; and a roller unit 200, disposed on an upper part of a cover member 95 attached to the housing 6 to be freely opened and closed, for conveying and feeding a paper sheet P1 set on the manual-feed tray 81 towards the printing part 2 when the cover member 95 is closed.

Disposed downstream of the paper roll containing part 1 is a guide member 10 constituting part of a conveyance path for guiding the paper web P2 to the printing part 2. On the other hand, disposed downstream of the manual-feed tray 81 is a guide plate 92 constituting part of a conveyance path for guiding the paper sheet P1 to the printing part 2. Furthermore, a conveyance drive roller 24 capable of being driven into rotation to convey the printing paper P1 or P2 is disposed downstream of a meeting point G of the guide member 10 and the guide plate 92 in the direction of paper conveyance.

Disposed in the upper part of the housing 6 and downstream of the printing part 2 in the direction of paper conveyance are a roller cutter 41 for cutting out an unnecessary part of printed printing paper P1 or P2, a back printing unit 4 for printing a serial number on the back side of each piece of printing paper P1 or P2, a drying unit U6 for drying the piece of printing paper P1 or P2 printed in the printing part 2, and two pairs of output rollers 46 for conveying the piece of printing paper P1 or P2 printed in the printing part 2 further downstream and outputting it. Each pair of output rollers 46 are vertically arranged and engaged against each other. Disposed downstream of the two pairs of output rollers 46 in the direction of paper conveyance is a paper output tray 5, extending outside from an output port 47 in the housing 6, for receiving the piece of printing paper P1 or P2 delivered by the pairs of output rollers 46.

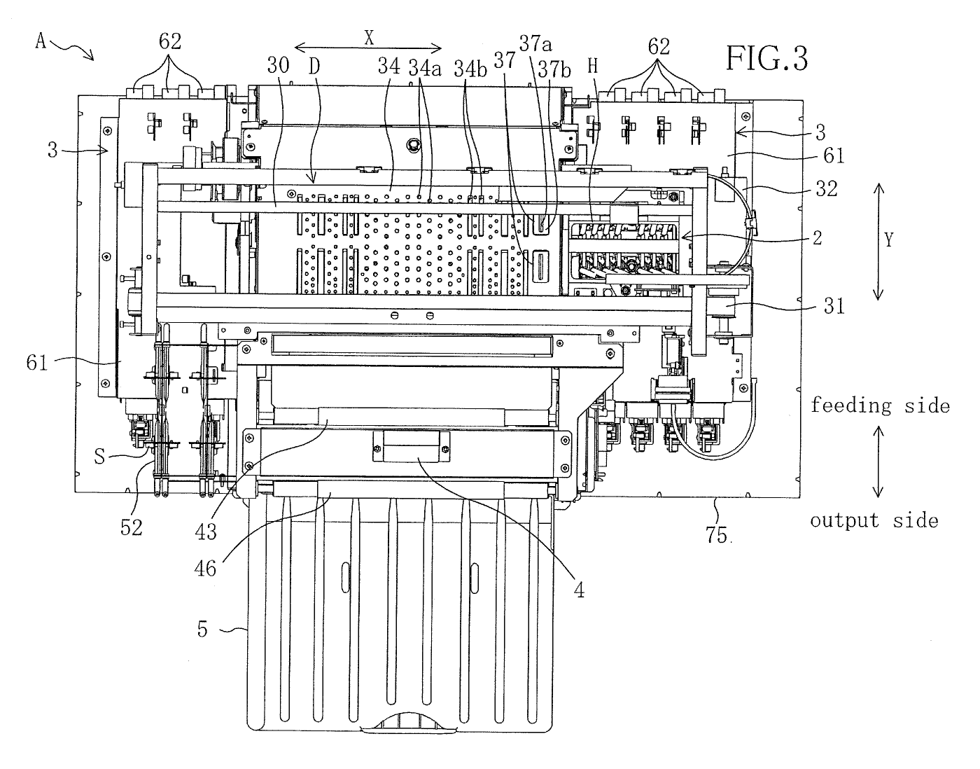

In this embodiment, the side of the housing 6 towards the paper output tray 5 (“output side” shown in FIG. 3) is referred to as the housing front side, the side thereof opposite to the paper output tray 5 (“feeding side” shown in FIG. 3) is referred to as the housing rear side, the left side thereof as viewed from the housing front side is referred to as the housing left side, and the right side thereof as viewed from the housing front side is referred to as the housing right side. Therefore, the right-to-left direction in FIG. 7 is the housing front-to-rear direction and the direction orthogonal to the drawing sheet of FIG. 7 is the housing right-to-left direction. The housing right-to-left direction coincides with the width direction of the paper sheet P1 set on and fed from the manual-feed tray 81 and the width direction of the paper web P2 contained in and fed from the paper roll containing part 1.

The printing part 2 includes a print head H (see FIGS. 2 to 4 and FIG. 7) for ejecting ink therefrom to the printing paper P1 or P2 and forming an image on it. The print head H is configured to be movable along a rail 30 extending in a main scanning direction X (see FIG. 3) coinciding with the width direction of the printing paper P1 or P2 (i.e., the housing right-to-left direction). Specifically, when the rotational force of a drive motor 32 is transmitted through a pulley to a drive belt 31, the print head H moves in the main scanning direction X according to the amount of rotation of the drive belt 31.

The print head H further includes two head units 38 and 38 (see FIG. 7) arranged along a sub-scanning direction Y (see FIG. 3) orthogonal to the main scanning direction X and coinciding with the direction of travel of the printing paper P1 or P2 (i.e., the housing front-to-rear direction). The print head H is configured to print a given image or characters on the printing paper P1 or P2 by ejecting ink through inkjet nozzles (not shown) formed in these two head units 38 and 38.

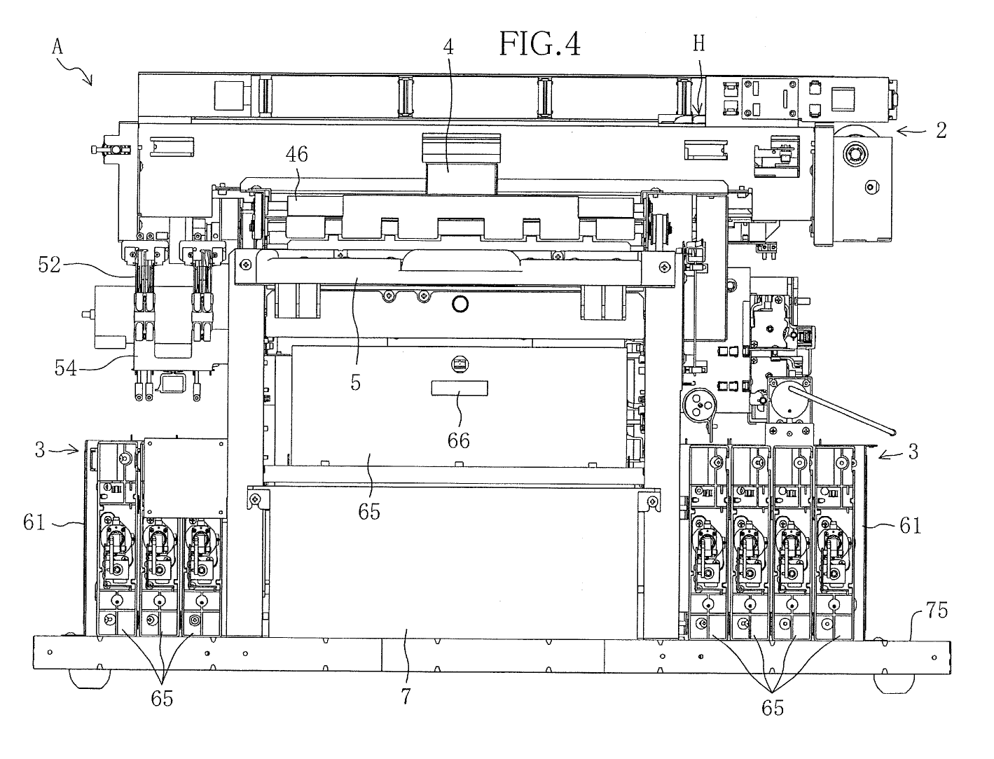

The ink storages 3 include their respective box-shaped cases 61 (see FIG. 4) disposed on the right and left of the inkjet printer A. These cases 61 contain seven removable ink cartridges in total (in FIG. 4, three in the left case 61 and four in the right case 61). The ink cartridges 62 are charged with different types of ink having different hues. Therefore, the ink cartridges 62 spent or being used can be replaced with new ones by removing them from the cases 61 and setting new ones in the cases 61. Seven types of ink charged in these ink cartridges 62 are yellow (Y), magenta (M), cyan (C), black (K), red (R), violet (V) and clear (CL).

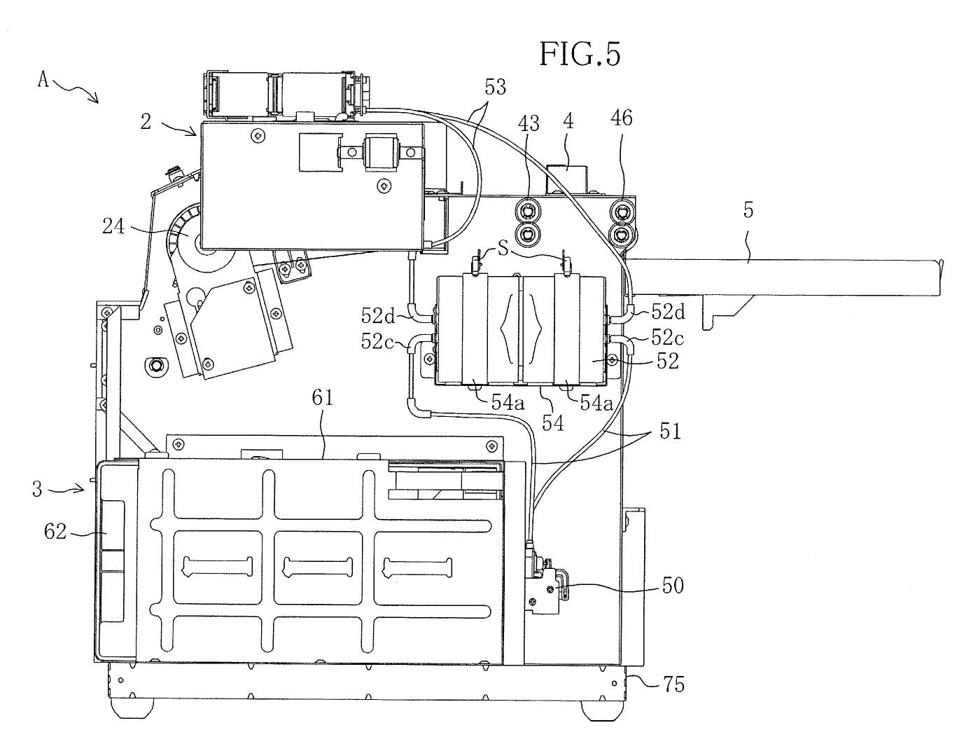

Furthermore, sub-tanks 52 (see FIGS. 4 and 5) for temporarily storing ink supplied from the ink cartridges 62 are disposed to the left as viewed from the output side of the inkjet printer A and at a height between the ink storages 3 and the printing part 2. These sub-tanks 52 are connected to the print head H of the printing part 2 and configured to supply different types of ink therein to the print head H by negative pressure produced in ejecting the these types of ink through the associated nozzles of the print head H.

### —Paper Conveyance Mechanism—

As shown in FIG. 7, the inkjet printer A is provided with a paper conveyance mechanism for pulling in a paper sheet P1 from the manual-feed tray 81 and conveying it along a given conveyance path. To form the conveyance path, the paper conveyance mechanism includes, in order from the manual-feed tray 81, a manual-feed unit U5, a printing unit U2, a cutter unit U3, the drying unit U6 and a paper output unit U4. Thus, image data is printed on the printing surface of the printing paper P1 or P2 located on the conveyance path in the printing unit U2 provided in the printing part 2. In this embodiment, for another paper feed path other than the feed path of a paper sheet P1 from the manual-feed tray 81 to the printing unit U2, the paper conveyance mechanism further includes a feed unit U1 configured to pull the leading edge of a paper web P2 out of the paper roll containing part 1 and feed it to the printing part 2.

In printing on a paper sheet P1, the paper conveyance mechanism is configured so that the manual-feed unit U5 feeds the paper sheet P1 set on the manual-feed tray 81 to the printing unit U2, the printing unit U2 then prints image data on the fed paper sheet P1 with the print head H while conveying the paper sheet P1 towards the cutter unit U3, the cutter unit U3 then cuts the printed paper sheet P1 in a given print size, the drying unit U6 then dries the paper sheet P1 and the paper output unit U4 conveys the paper sheet P1 out to the paper output tray 5. Hereinafter, the upstream side and downstream side in the direction of conveyance of the paper sheet P1 being conveyed during printing is referred to simply as the upstream side and downstream side, respectively.

The feed unit U1 includes a core roller 21 for winding a paper web P2 in a roll thereon to contain the rolled paper web P2 in the paper roll containing part 1, a transverse restriction roller 22 for restricting the transverse position of the paper web P2 pulled out of the core roller 21, a closing roller 23 described later, a conveyance drive roller 24 capable of being driven into rotation by an unshown electric motor to convey the paper web P2, and two pinch rollers 25 opposed to the conveyance drive roller 24 and engageable against the conveyance drive roller 24 to pinch the paper web P2 together with the conveyance drive roller 24.

The feed unit U1 is configured to pull the paper web P2 out of the paper roll containing part 1 and also feed it to the printing part 2 by the rotation of the conveyance drive roller 24. Although in this embodiment the feed unit U1 includes the transverse restriction roller 22, it may include a guide for restricting the transverse position of the paper web P2 instead.

The closing roller 23 is provided to ensure the airtightness of the paper roll containing part 1 and thereby prevent the interior of the paper roll containing part 1 from falling into a low-humidity condition. Specifically, the walls defining the paper roll containing part 1 need to have a paper lead-out opening 9 for leading the paper web P2 out of the paper roll containing part 1 to the other space of the interior of the housing 6 (i.e., the space thereof containing the printing part 2). If the paper lead-out opening 9 remains open, the airtightness of the paper roll containing part 1 cannot be ensured. Therefore, the paper lead-out opening 9 is provided with the closing roller 23 that closes the paper lead-out opening 9 to allow the paper web P2 to pass through it.

At least the outer peripheral part of the closing roller 23 is made of an elastically deformable material, such as foam including sponge or rubber. The closing roller 23 is configured to contact the paper web P2 passing through the paper lead-out opening 9 while elastically deforming radially inwardly and be thereby driven into rotation. During the contact, the paper web P2 is pressed against the guide member 10 disposed opposite to the closing roller 23 (but its pressing force is substantially small). Thus, the paper web P2 can pass through the paper lead-out opening 9 with little resistance from the closing roller 23 while the paper roll containing part 1 can keep its airtightness.

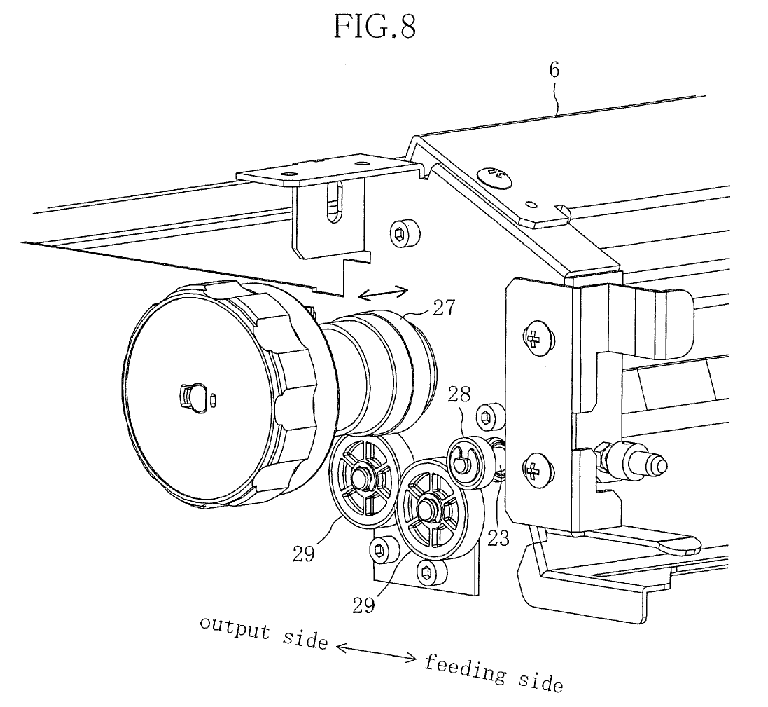

The closing roller 23 is configured to act as a drive roller for positively feeding forward the paper web P2 in the direction of paper conveyance and rewinding the paper web P2. The rotation of the closing roller 23 is implemented by transmitting the rotational driving force of the conveyance drive roller 24 to the closing roller 23. Specifically, as shown in FIG. 8, a solenoid clutch 27 (driving force transmission device) is attached to one end of the roller shaft of the conveyance drive roller 24 and is configured to be freely movable in the axial direction of the roller shaft. A drive gear 28 is attached to one end of the roller shaft of the closing roller 23. Furthermore, two coupling gears 29, 29 are disposed between the solenoid clutch 27 and the drive gear 28 and configured to transmit the rotational driving force of the conveyance drive roller 24 through themselves to the drive gear 28.

In the above gear arrangement, when the solenoid clutch 27 is brought into a position shown in FIG. 8, it comes into a transmission state in which the rotational driving force of the conveyance drive roller 24 is transmitted via the solenoid clutch 27 and the coupling gears 29, 29 to the drive gear 28 and the closing roller 23 is thereby driven into rotation in synchronism with the conveyance drive roller 24. On the other hand, when the solenoid clutch 27 is moved in the axial direction of the roller shaft to disengage it from the adjacent coupling gear 29, it comes into a non-transmission state in which it does not transmit the rotational driving force of the conveyance drive roller 24 to the closing roller 23 and thereby stops the rotation of the closing roller 23.

In the above manner, whether or not to drive the closing roller 23 into rotation can be selected simply by switching the solenoid clutch 27 between ON and OFF using the driving force of an unshown electric motor for driving the conveyance drive roller 24 into rotation. Therefore, there is no need to additionally provide a motor or the like exclusive for the closing roller 23, which is advantageous in space saving and cost reduction of the inkjet printer A.

When the paper web P2 is not in the paper lead-out opening 9, the closing roller 23 is in contact with the guide member 10. Also in this case, the airtightness of the paper roll containing part 1 can be ensured. In the paper roll containing part 1 thus keeping airtightness, a container 13 containing water and opening at its top is disposed. The water in the container 13 liquefies into vapor, whereby the interior of the paper roll containing part 1 is efficiently humidified.

Thus, even if the inkjet printer A itself is put under low-humidity conditions for a long time, the interior of the paper roll containing part 1 can be kept at an appropriate humidity (where printing paper can be used within the relative humidity range of 30% to 75%, preferably 40% to 60%), which prevents the paper web P2 from producing such a curl that the widthwise middle of the paper web P2 rises on the printing surface side with respect to both widthwise ends thereof.

The conveyance drive roller 24 is configured to be rotated forward by an unshown electric motor to pull the paper web P2 out of the paper roll containing part 1 and feed it to the printing part 2 and rotated backward by the electric motor to return the paper web P2 to the paper roll containing part 1.

Thus, the inkjet printer A can cut off the printed part of the paper web P2 into a given size by the cutter unit U3 downstream of the printing part 2, then return the remaining long paper web P2 after the cutting upstream and restart printing with the leading edge of the remaining paper web P2 or can return the long paper web P2 after the cutting into the paper roll containing part 1, feed a cut paper sheet P1 to the printing part 2 through the manual-feed unit U5 and print on it. Furthermore, in replacing the long paper web P2 with new one, the long paper web P2 pulled out of the paper roll containing part 1 can be returned into the paper roll containing part 1.

In rewinding the paper web P2 into the paper roll containing part 1, the above-stated solenoid clutch 27 is turned ON (engaged) to drive the closing roller 23 in synchronism with the conveyance drive roller 24. This is advantageous because the paper web P2 can be prevented from slacking between the closing roller 23 and the conveyance drive roller 24.

Furthermore, in feeding a paper sheet P1 to the printing part 2 to print on it, the paper web P2 not in use for printing is put on standby at a standby position in which its leading edge is located upstream of the meeting point G to avoid interference with the conveyance of the paper sheet P1 and the closing roller 23 bears against a margin Pa (see FIG. 9) of the paper web P2.

As shown in FIG. 9, the paper web P2 has: to-be-printed regions Pb on each of which an image is to be printed; and margins Pa at the leading edge thereof and between each two of the to-be-printed regions Pb, Pb adjacent in the longitudinal direction thereof. In the case of FIG. 9, each to-be-printed region Pb is a region defined by the dash-double-dot line. An image will be printed on the to-be-printed region Pb by ejecting ink from the print head H to the to-be-printed region Pb.

In an example shown in FIG. 9, the paper web P2 is on standby with the closing roller 23 bearing against the margin Pa at the leading edge of the paper web P2. Therefore, all the to-be-printed regions Pb of the paper web P2 are inside the paper roll containing part 1 having a good moisture retention condition. Thus, every single to-be-printed region Pb is prevented from having different ink absorptivities within it. This prevents a print obtained by printing the paper web from causing color shading, resulting in providing a high-quality print.

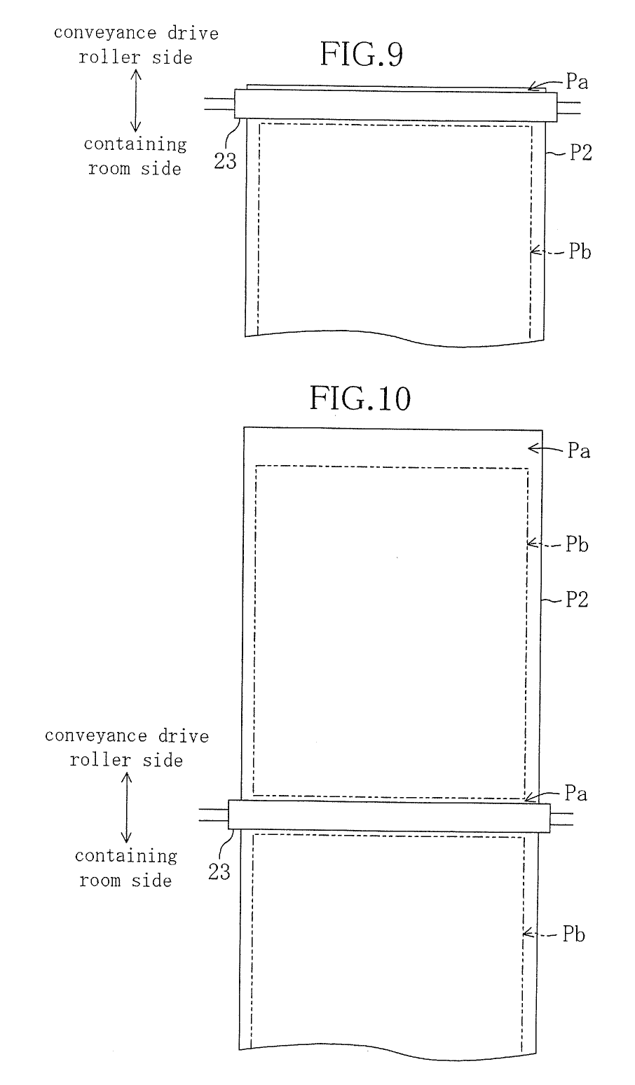

On the other hand, in another example shown in FIG. 10, the paper web P2 is on standby with the closing roller 23 bearing against the margin Pa between two adjacent to-be-printed regions Pb, Pb. Therefore, only the first to-be-printed region Pb of the paper web P2 is outside the paper roll containing part 1 and the rest are inside the paper roll containing part 1. Thus, even if the humidity condition differs between inside and outside the paper roll containing part 1, each single to-be-printed region Pb is prevented from having different ink absorptivities within it. This prevents a print obtained by printing on the paper web from causing color shading, resulting in providing a high-quality print.

Next, a description is given of a procedure for detecting the leading edge of the paper web P2. When the power is turned on, the paper web P2 is first fed to the printing part 2 and its leading edge is detected by an unshown leading edge detection sensor provided on the print head H. After the leading edge is detected, the paper web P2 is subsequently conveyed to the vicinity of the exit of a paper holder D described later and the width of the paper web P2 is detected thereat by the leading edge detection sensor. After the leading edge and width of the paper web P2 are detected in the above manner, the paper web P2 is rewound to its standby position by the conveyance drive roller 24 and the closing roller 23. In immediately printing on the paper web P2, the paper web P2 is rewound to the printing start position.

On the other hand, in printing on a paper sheet P1, the manual-feed unit U5 feeds the paper sheet P1 set on the manual-feed tray 81 to the printing unit U2, the printing unit U2 then prints image data on the fed paper sheet P1 with the print head H while conveying the paper sheet P1 towards the cutter unit U3, the cutter unit U3 then cuts the printed paper sheet P1 in a given print size and the paper output unit U4 conveys the paper sheet P1 out to the paper output tray 5.

The manual-feed unit U5 includes the roller unit 200 for guiding the paper sheet P1 to the printing part 2. The roller unit 200 includes a drive roller 202 and a driven roller 201. The manual-feed unit U5 guides the paper sheet P1 from the manual-feed tray 81 into the printer body 90 by driving the drive roller 202 into rotation.

Next, a description is given of a procedure for detecting the leading edge of the paper sheet P1. First, the paper sheet P1 is fed to the printing part 2 and its leading edge is detected by the leading edge detection sensor provided on the print head H. After the leading edge is detected, the paper sheet P1 is subsequently conveyed to the vicinity of the exit of the paper holder D and the width of the paper sheet P1 is detected thereat by the leading edge detection sensor. After the leading edge and width of the paper sheet P1 are detected in the above manner, the paper sheet P1 is conveyed backward to the printing start position by the conveyance drive roller 24.

The printing unit U2 includes: the paper holder D (see FIGS. 3 and 7) for holding by suction the printing paper P1 or P2 at a position allowing printing of the print head H; and a pair of paper conveyance rollers 33 disposed downstream of the paper holder D and engaged against each other. The conveyance drive roller 24 and the pinch rollers 25 in the feed unit U1 are used also as components of the printing unit U2 and act to convey the printing paper P1 or P2 in the printing unit U2.

The paper holder D includes: a platen 34 having suction holes 34a (see FIG. 3) opening at the surface (top); and a fan 35 (see FIG. 7) as a suction device for sucking the printing paper P1 or P2, which is fed onto the platen 34 by the feed unit U1, through the suction holes 34a and thereby holding it on the surface of the platen 34. The platen 34 is composed of a plate material. Disposed on the back (bottom) of the platen 34 is a case 36 forming a space together with the platen 34. The fan 35 is disposed under the case 36. The suction holes 34a pass through the platen 34 in the thickness direction and are communicated with the space in the case 36. The space in the case 36 is communicated through an opening formed in the bottom of the case 36 with the inlet opening of the fan 35. When the fan 35 is operated, negative pressure is produced through the suction holes 34a on the surface of the platen 34, whereby the printing paper P1 or P2 is held on the surface of the platen 34 by suction.

The platen 34 further includes: flashing parts 37 (see FIG. 3) for receiving a small amount of ink ejected through the ink-jet nozzles in the head units 38 of the print head H to prevent the ink viscosity from increasing in printing; and caps (not shown) disposed at a standby position of the print head H during deactivation of the inkjet printer A and configured to cover the ink-jet nozzles in the head units 38 of the print head H to prevent the ink viscosity from increasing.

Each flashing part 37 includes an opening 37a (see FIG. 3) formed in the platen 34. Disposed below the flashing part 37a in the platen 34 is a case (not shown) forming a space communicated with the opening 37a. The case is communicated with a waste tank 7 (see FIGS. 2 and 7) disposed in the lower part of the housing 6 towards the housing front side. Furthermore, an ink absorbing material 37b made of sponge capable of absorbing ink is disposed in the opening 37a. The ink infiltrating the ink absorbing material 37b accumulates in the space in the case located below the associated flashing part 37. Thus, the ink ejected towards the openings 37a of the flashing parts 37 is led into the waste tank 7 after accumulating in the spaces in the cases.

Each cap is, although not particularly shown in the figures, configured to have a space put under negative pressure to draw a slight amount of ink through the ink-jet nozzles into the space when it covers the bottom surface of the print head H. Thus, it can be prevented that the ink in the ink jet nozzles increases the viscosity to become difficult to eject.

The print head H includes two head units 38 having a plurality of ink-jet nozzles and disposed in two stages in the sub-scanning direction Y on the bottom thereof (the surface opposed to the platen 34), as described previously. However, the number of head units 38 may not necessarily be two and may be one or may be three or more.

Both the head units 38 have the same structure and each of them is composed of seven nozzle arrays, arranged in the main scanning direction X, for ejecting different types of ink of different colors therefrom. In each nozzle array, ink-jet nozzles as described above are aligned in the sub-scanning direction Y. Thus, each head unit 38 can make color images independently of the other. The printing paper P1 or P2 is intermittently (stepwise) conveyed in certain unit amounts of conveyance in the sub-scanning direction Y by the conveyance drive roller 24. During each stopping time of the printing paper P1 or P2 in the course of intermittent conveyance, the print head H scans one way (makes a forward scanning or a backward scanning) in the main scanning direction X. During the scanning, seven different types of ink of different colors are concurrently ejected through the associated ink-jet nozzles of each head unit 38 to the printing surface of the printing paper P1 or P2. In other words, after a single scanning of the print head H, the printing paper P1 or P2 is conveyed by a unit amount of conveyance and the print head H then scans once. By repeating this operation, a desired image is printed. In this embodiment, in order to eject ink from the print head H, common piezoelectric technology is employed in which the volume of a pressure chamber charged with ink is changed by a piezoelectric element and ink is thereby ejected through the ink-jet nozzles communicated with the pressure chamber.

The cutter unit U3 includes a roller cutter 41 and is configured to cut the printing paper P1 or P2 into a given size (length) by moving the roller cutter 41 in the width direction at an appropriate position of the length of the printing paper P1 or P2 while rotating the roller cutter 41. Disposed below the roller cutter 41 is a chip collecting box 65 for collecting chips of the printing paper P1 or P2 formed by the cutting. The chip collecting box 65 is configured so that the operator can slide it out of the housing 6 by pulling its handle 66 and take out the chips collected in it. The housing front side of the chip collecting box 65 is made of clear plastic material to allow visual check for collection of chips.

Furthermore, the cutter unit U3 is configured to convey the printing paper P1 or P2 to the paper output unit U4 by means of a pair of conveyance rollers 43 engaged against each other. The back printing unit 4 is disposed between the cutter unit U3 and the paper output unit U4. In the back printing unit 4, a serial number or the like is printed on the back (underside) of the printing paper P1 or P2 passing through it.

The paper output unit U4 includes the two pairs of output rollers 46 and 46 for conveying the printing paper P1 or P2 and delivering it to the paper output tray 5. Disposed between the two pairs of output rollers 46, 46 in the paper output unit U4 is the drying unit U6 for drying the printing paper P1 or P2 by blowing dry air against the printing paper P1 or P2.

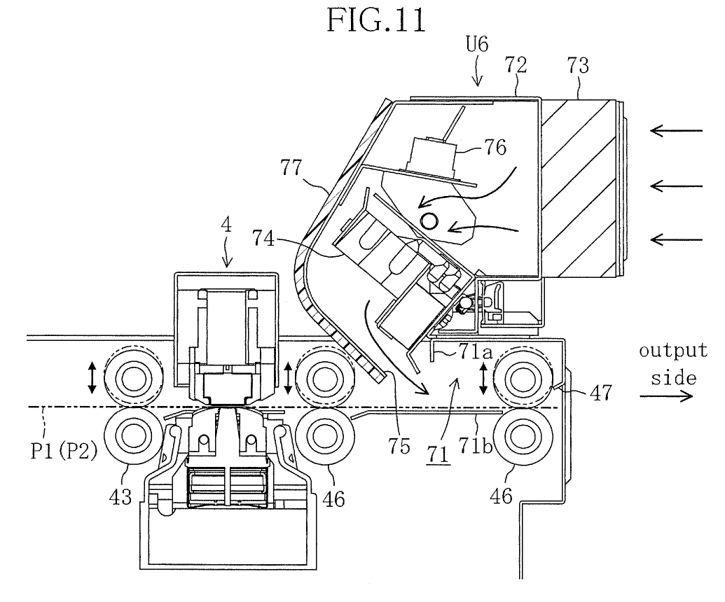

The drying unit U6 includes, as shown in FIG. 11, a drying chamber 71 disposed on the conveyance path of the printing paper P1 or P2 and a dryer 72 for supplying dry air to the drying chamber 71. The drying chamber 71 is defined by an upper partition wall 71a and a lower partition wall 71b that are opposed to each other with the printing paper P1 or P2 therebetween, and constitutes a retention space for retaining dry air blown against the printing paper P1 or P2 from the dryer 72.

The dryer 72 includes a plurality of intake fans 73 disposed in the housing 6 at laterally spaced intervals to take air from the outside into the dryer 72, a heater 74 for heating the air taken in by the intake fans 73, an exhaust nozzle 75, disposed at the lower end of the dryer 72 and opening downstream in the direction of paper conveyance, for blowing dry air heated by the heater 74 therethrough downstream in the direction of paper conveyance, and a safety thermostat 76 for detecting the internal temperature of the dryer 72 and stopping the heater 74 in time of necessity. A heat insulating material 77 is attached to an upstream portion of the outer wall of the dryer 72 in the direction of paper conveyance, also including the exhaust nozzle 75.

Since such a drying unit U6 is provided, this promotes the drying of ink ejected from the print head H to the printing paper P1 or P2 even if the ink on the printed piece of paper is not yet dried. This is advantageous in preventing inconveniences caused when printed pieces of printing paper P1 or P2 are stacked one after another on the paper output tray 5, such as a phenomenon that ink on each printed piece of paper is not uniformly dried to cause color shading of printed images.

### —Ink Supply System—

As shown in FIG. 5, the ink supply system for the inkjet printer A is configured to deliver ink in the ink cartridges 62 of the ink storages 3 disposed on both lateral sides of the inkjet printer A via solenoid valves 50 and delivery tubes 51 to the sub-tanks 52 and supply the ink in the sub-tanks 52 via flexible tubes 53 to the print head H.

The ink is delivered from the ink cartridges 62 to the sub-tanks 52 by pressurized air supplied into the ink cartridges 62 by a pressure pump (not shown), and then flows from the sub-tanks 52 to the print head H by negative pressure produced in pressure chambers upon ink ejection through the nozzles of the print head H.

Each sub-tank 52 is formed in the shape of a bag using a flexible material such as a resin sheet. The number of sub-tanks 52 is seven to correspond to the number of ink types having different hues. The seven sub-tanks 52 are disposed at an appropriate height in relation to the print head H so that the ink can be supplied at an appropriate pressure to the print head H.

As described above, the ink in the ink cartridges 62 is once stored in the sub-tanks 52 and then supplied from the sub-tanks 52 to the print head H. Therefore, the ink cartridges 62 can be replaced without interruption of printing. Furthermore, since the sub-tanks 52 serve also as pressure dampers, this prevents that pressure variations caused in the ink cartridges 62 are directly transmitted to the print head H and in turn prevents that an excessive pressure acts on the print head H to cause problems, such as ink leakage.

As described so far, according to the inkjet printer A of this embodiment of the present invention, when the paper web P2 is not in use for image printing, it is put on standby at a standby position in which its leading edge is located upstream of the meeting point G to avoid interference with the conveyance of the paper sheet P1 and the closing roller 23 bears against one of the margins Pa of the paper web P2. Therefore, each single to-be-printed region Pb of the surface of the paper web P2 can be kept in a uniform moisture retention condition. In other words, at the standby position of the paper web P2, the whole area of each single to-be-printed region Pb of the paper web P2 is inside or outside the paper roll containing part 1. Therefore, even if the humidity condition differs between inside and outside the paper roll containing part 1, each single to-be-printed region Pb is prevented from having different ink absorptivities within it. This prevents a print obtained by printing on the paper web from causing color shading, resulting in providing a high-quality print.

Although this embodiment describes the case where the paper roll containing part 1 contains a single paper web P2, the paper roll containing part 1 may contain a plurality of types of paper webs P2.

As seen from the above description, the present invention has the following highly practical effect: to provide an inkjet printer that prevents a single print from having color shading therewithin and thereby achieves high-quality printing. Therefore, the present invention is very useful and has high industrial applicability.

What is claimed is:

1. An inkjet printer comprising: a plurality of containing parts for containing a plurality of types of paper, one containing part for each type of paper; and a plurality of conveyance paths provided one for each of the plurality of containing parts, the inkjet printer being configured to select one of the plurality of conveyance paths for each type of paper, convey the paper to a print head along the selected conveyance path and print an image on the paper,
wherein the inkjet printer further comprises a conveyance roller, disposed downstream of a meeting point of the downstream ends of the plurality of conveyance paths in a direction of paper conveyance, for conveying the paper to the print head,
the plurality of types of paper include at least one type of long rolled paper web having: a plurality of to-be-printed regions on each of which an image is to be printed; and margins provided at the leading edge of the paper web and between each two of the plurality of to-be-printed regions adjacent in a longitudinal direction of the paper web,
the containing part for containing the paper web comprises a containing room including an airtight space,
the inkjet printer further comprises a closing member, disposed in the vicinity of an opening for paper conveyance opening into the containing room, for closing the opening, and
the inkjet printer is configured so that, out of the plurality of types of paper, the paper web not in use for printing is put on standby at a standby position in which the leading edge of the paper web is located upstream of the meeting point in the direction of paper conveyance and the closing member bears against one of the margins of the paper web.

2. The inkjet printer of claim 1, wherein
the containing room is kept within a predetermined range of humidities, and
the inkjet printer is configured so that, out of the plurality of types of paper, the paper web not in use for printing is put on standby at a standby position in which the closing member bears against the margin at the leading edge of the paper web.

3. The inkjet printer of claim 1, wherein a drive roller for feeding forward the paper web in the direction of paper conveyance and rewinding the paper web is disposed between the conveyance roller and the containing room.

4. The inkjet printer of claim 3, wherein the drive roller is composed of the closing member formed into a roller.

5. The inkjet printer of claim 4, further comprising a driving force transmission device configured to be switchable between a transmission state in which the rotational driving force of the conveyance roller is transmitted to the drive roller to drive the drive roller into rotation in synchronism with the conveyance roller and a non-transmission state in which the rotational driving force of the conveyance roller is not transmitted to the drive roller to stop the drive roller.
